(19) United States
(12) Patent Application Publication
(10) Pub. No.: US 2026/0303341 A1
(43) Pub. Date: Oct. 1, 2026

(54) TRANSFORMING HSM PROTECTED KEY TO FW PROTECTED KEY

(71) Applicant: INTERNATIONAL BUSINESS MACHINES CORPORATION, ARMONK, NY (US)

(72) Inventors: Reinhard Theodor Buendgen, Tuebingen (DE); Silvio Dragone, Olten (CH); Volker Urban, Böblingen (DE); Benedikt Wenz, Böblingen (DE); Harald Freudenberger, Fellbach (DE); Andreas Kremser, Böblingen (DE); Timo Schmetzer, Ostfildern (DE)

(21) Appl. No.: 19/092,148

(22) Filed: Mar. 27, 2025

(51) Int. Cl. H04L 9/08; G06F 9/455

(52) U.S. Cl. CPC H04L 9/088; G06F 9/45558; G06F 2009/45587

(57) ABSTRACT

A TEE may store a connection credential (CC). The TEE may receive a request from a secVM for data to open a connection based on the CC with an HSM. The TEE may provide the data to open the connection based on the CC to the secVM. The TEE may derive a KTK using the CC, a host private key, and an HSM public key. The TEE may provide a KTK handle to the secVM. The TEE may receive, from the secVM, the KTK handle and a KTK(K), wherein the plaintext key (K) corresponds to the HSM protected key. The TEE may unwrap the KTK(K) using the KTK referenced by the KTK handle to produce the K. The TEE may wrap the K with a secVM specific host FW wrapping key (FWWK) to create the FWWK(K). The TEE may provide the FWWK(K) to the secVM.

### BACKGROUND

The present disclosure relates to confidential computing and hardware security modules.

A hypervisor, also known as a virtual machine monitor (VMM), is software that enables virtual machines (VMs), each with its own operating system, to run on a physical server. The hypervisor pools and allocates physical computing resources as needed by the VMs. A secure VM (secVM) in confidential computing mode uses a trusted execution environment (TEE) to maintain state, metadata, and secrets on behalf of the secVM. A hardware security module (HSM) is hardware that processes cryptographic operations and does not allow plaintext encryption keys to leave the secure cryptographic environment of the HSM.

### SUMMARY

In some aspects, the techniques described herein relate to a method for transforming a hardware security module (HSM) protected key (HSM(K)) into host firmware (FW) protected key (FWWK(K)) that is specific to a secure virtual machine (secVM), the method including: storing, by a trusted execution module (TEE), a connection credential (CC); receiving a request from the secVM for data to open a connection based on the CC with an HSM; providing, by the TEE, the data to open the connection based on the CC to the secVM; deriving, by the TEE, a key transport key (KTK) using the CC, a host private key, and an HSM public key; providing, by the TEE, a KTK handle to the secVM; receiving, by the TEE and from the secVM, the KTK handle and a wrapped plaintext key (KTK(K)) wrapped using the KTK, wherein the plaintext key (K) corresponds to the HSM protected key; unwrapping, by the TEE, the KTK(K) using the KTK referenced by the KTK handle to produce the K; wrapping, by the TEE, the K with a secVM specific host FW wrapping key (FWWK) to create the FWWK(K); and providing, by the TEE, the FWWK(K) to the secVM.

In some aspects, the techniques described herein relate to a system for transforming a hardware security module (HSM) protected key (HSM(K)) into a host firmware (FW) protected key (FWWK(K)) that is specific to a secure virtual machine (secVM), the system including: a trusted execution environment (TEE) including hardware and firmware configured to: store a connection credential (CC), provide the data to open the connection based on the CC to the secVM, derive a key transport key (KTK) using the CC and a host private key, provide a KTK handle to the secVM, receive, from the secVM, the KTK handle and a wrapped plaintext key (KTK(K)) wrapped using the KTK, wherein the plaintext key (K) corresponds to the HSM protected key, KTK(K) using the KTK referenced by the KTK handle to produce the K, wrap the K with a secVM specific host FW wrapping key (FWWK) to create the FWWK(K), and provide the FWWK(K) to the secVM; and the secVM configured to: establish a connection with the HSM using the data to open the connection based on the CC from the TEE; communicate a request (R) to convert the HSM (K) into a host FW protected key to the HSM via the connection; in response to the R, receive the KTK(K) from the HSM; provide the KTK(K) and the KTK handle to the TEE; and receive the FWWK(K) from the TEE.

In some aspects, the techniques described herein relate to a computer program product including a computer-readable storage medium storing instructions that, when executed by a processor, cause the processor to perform a method for transforming a hardware security module (HSM) protected key (HSM(K)) into host firmware (FW) protected key (FWWK(K)) that is specific to a secure virtual machine (secVM), the method including: requesting data to open a connection based on connection credentials (CC) with the HSM from a trusted execution environment (TEE); receiving the data to open the connection based on the CC; receiving a key transport key (KTK) handle from the TEE; establishing the connection with the HSM using the data; requesting to transform the HSM(K) to a host protected key via the connection; receiving a wrapped plaintext key (KTK(K)) wrapped using the KTK from the HSM; providing the KTK(K) and the KTK handle to the TEE; and receiving the FWWK(K) from the TEE.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an example computing environment, according to embodiments of the present disclosure.

FIG. 2 depicts a block diagram of an example computing environment, according to embodiments.

FIG. 3 depicts a flowchart of an example method for a secure virtual machine to establish a secure connection to a remote hardware security module, according to embodiments.

FIG. 4 depicts a flowchart of an example method for a trusted execution environment establishing a secure connection between a secure virtual machine and a remote hardware security module, according to embodiments.

FIG. 5 depicts a flowchart of an example method for a hardware security module to establish a secure connection to a remote secure virtual machine, according to embodiments.

FIG. 6 depicts a flowchart of an example method for a secure virtual machine transforming an HSM protected key into a host FW protected key, according to embodiments

FIG. 7 depicts a flowchart of an example method for a TEE transforming an HSM protected key into a host FW protected key, according to embodiments.

FIG. 8 depicts a flowchart of an example method for a hardware security module transforming an HSM protected key into a host FW protected key, according to embodiments.

FIG. 9 depicts a block diagram of an example computing environment showing an example flow of keys and credentials used in transforming an HSM protected key into a host FW protected key, according to embodiments.

FIG. 10 depicts a sequence diagram of example operations between a secure virtual machine, hardware security module, and trusted execution environment, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to secure virtual machines (secVMs), and more particular aspects relate to transforming a hardware security module (HSM) protected key into a host FW protected key. While the present disclosure is not necessarily limited to such applications, various aspects of the disclosure may be appreciated through a discussion of various examples using this context.

Allowing a virtual machine (VM) to use a remote HSM to generate and use keys can raise security concerns. If an entity is able to steal the keys and/or other data from the virtual machine, they may be able access the remote HSM and use the stolen keys via a different VM.

Methods are described herein for securely connecting a secVM utilizing a trusted execution environment (TEE) to a remote HSM such that a different VM is unable to use keys generated by the HSM via the secure connection. The secVM cannot access secrets maintained by TEE, unless the TEE explicitly returns the secrets to the secVM, and then the secVM can only see the secret in the form it was returned (e.g., as an encrypted secret). The plaintext data used to open a secure connection with the HSM is stored within the TEE on behalf of the secVM. Secure keys generated by the HSM may be bound to the specific connection over which the HSM provides the secure key to the secVM. The remote HSM may be capable of connecting to multiple secVMs, but each connection may be associated with a different connection credential.

Typically, firmware protected keys are tied to a specific instance of a VM, such that the firmware protected key is rendered useless when the VM is stopped. In order to have the key survive, it can be protected by an HSM and a system with access to the HSM can request the HSM to transform the HSM protected key into an equivalent firmware protected key. For example, in IBM Z the Crypto Express HSMs support a secure guest asking the HSM to transform an HSM protected key into a host FW protected key, where the HSM then negotiates with the protected FW to transform the HSM protected key into the FW protected key. This is possible because the HSM is physically connected to the hardware and trusts the hardware that it is connected to.

However, when a secVM is running on a host remote from the HSM, there is not a physical connection that allows for establishing trust between the HSM and the protected FW. Thus, there must be an alternative way to establish trust in order to transform the HSM protected key into a FW protected key.

According to embodiments of the present disclosure, a secVM utilizes a TEE to transform an HSM protected key (HSM(K)) into a host FW protected key (FWWK(K)) that is specific to the secVM. The HSM(K) may be bound to a particular connection credential associated with the secure connection over which the HSM(K) was generated. The remote HSM may be preconfigured to have access to a host public key. The host public key may be within a certificate that has been loaded into the HSM. The secVM obtains data to open a connection with a remote HSM based on a connection credential from the TEE. The TEE also derives a key transport key (KTK) from the connection credential and an HSM public key and provides a KTK handle to the secVM. The KTK handle is a reference to the KTK. For example, the KTK handle may be a name that identifies the KTK or a location where the KTK is stored. The secVM then establishes the connection with the remote HSM based on the connection credential. The secVM sends a request, via the connection, to transform a HSM protected key (HSM(K)) into a host FW protected key. The HSM derives the KTK based on the host public key, an HSM private key, and the connection credential associated with the connection. The HSM encrypts a plaintext key (K), corresponding to the HSM(K), using the KTK to generate KTK(K). The HSM returns the KTK(K) to the secVM. The secVM sends the KTK(K) and the KTK handle to the TEE. The TEE decrypts the KTK(K) using the KTK to obtain the K. The TEE encrypts the K using a host firmware wrapping key (FWWK) specific to the secVM to generate FWWK(K). The TEE returns FWWK(K) to the secVM. The secVM can then use the FWWK(K) to perform cryptographic operations. The TEE may be configured to reject all operations using the KTK handle except an operation to unwrap a key using the KTK and return the resulting unwrapped key wrapped by the FWWK.—Alternative schemes to negotiate KTK between the HSM and TEE like an RSA based scheme or a key encapsulation method (KEM) based scheme or hybrid scheme can be used instead of the Diffie-Hellman scheme described above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as module 190. In addition to module 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and module 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

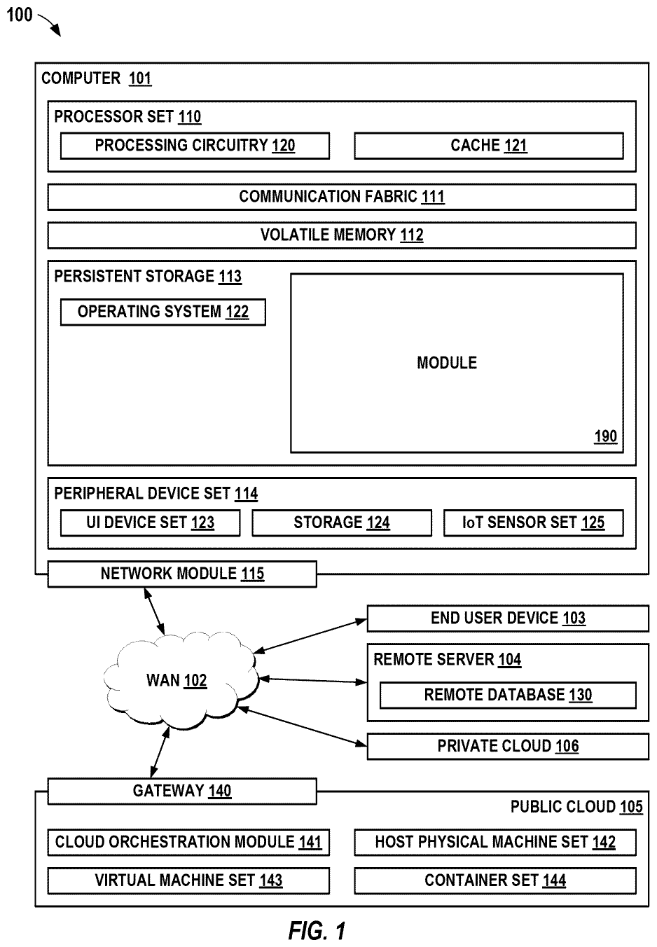

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in module 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in module 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

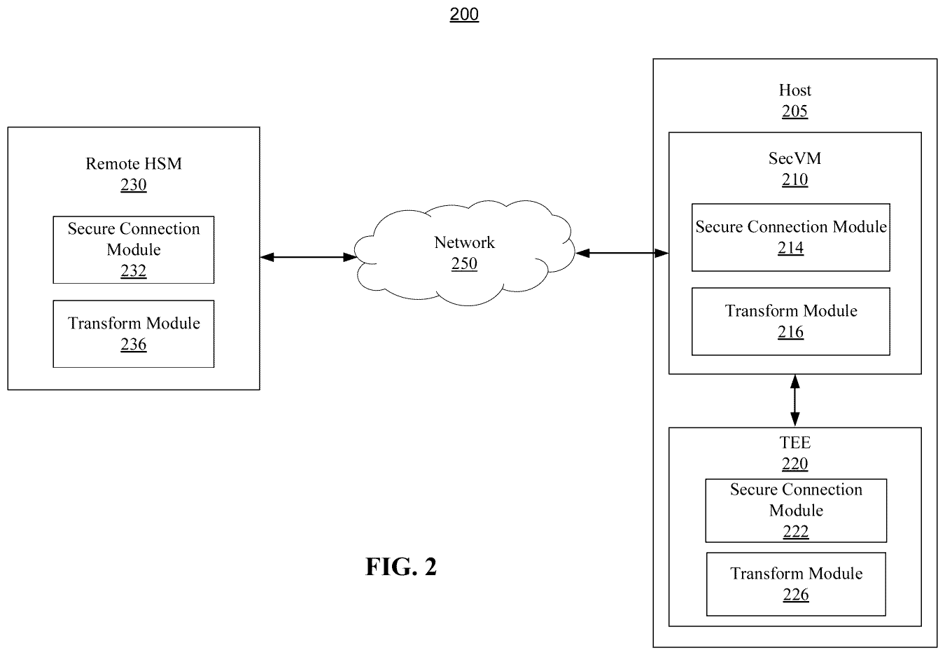

Referring now to FIG. 2, a block diagram of an example computing environment 200 is depicted according to embodiments. Computing environment 200 includes secVM 210, TEE 220, and remote HSM 230. SecVM 210 and TEE 220 are within a host system 205 such as, for example, a server. SecVM 210 is a VM running in a confidential computing mode (also known as a secure (execution) guest (SE-guest)). TEE 220 is trusted hardware and firmware used to run a VM in confidential computing mode. TEE 220 may be configured to maintain state, metadata, and secrets on behalf of secVM 210. SecVM 210 may run on a server that contains TEE 220. Remote HSM 230 is an HSM that can be connected to over a network, such as network 250. Remote HSM 230 may be an HSM that does not utilize any user management, such that it will act on requests from any VM that connects to the HSM. The modules depicted in FIG. 2 may be implemented using any suitable combination of software and/or hardware.

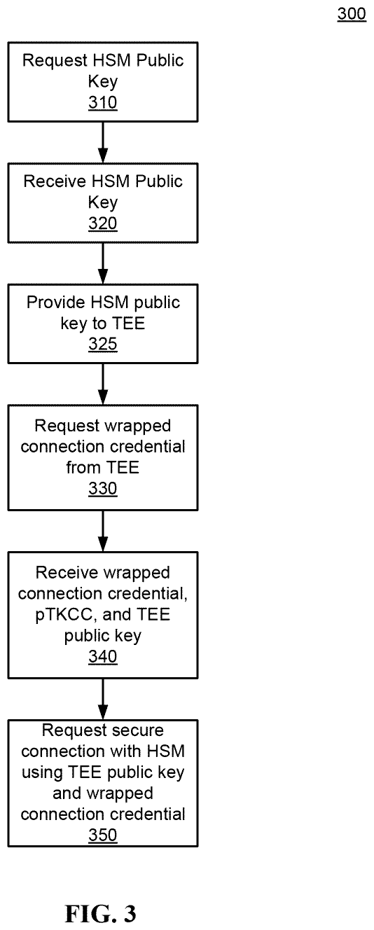

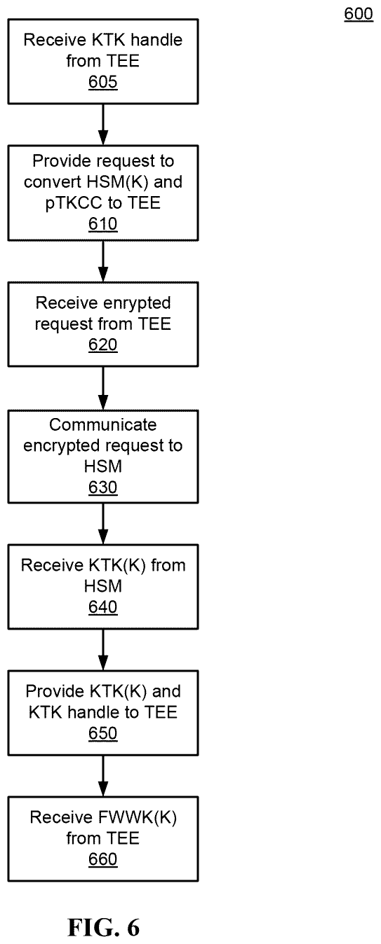

SecVM 210 contains secure connection module 214 configured to establish a secure connection with remote HSM 230 using TEE 220. Secure connection module may be configured to perform some or all of the operations of method 300 described herein and depicted in FIG. 3. SecVM 210 further contain transform module 216 configured to perform operations to transform an HSM protected key into a host firmware protected key. Transform module 216 may be configured to perform some or all of the operations of method 600 described herein and depicted in FIG. 6.

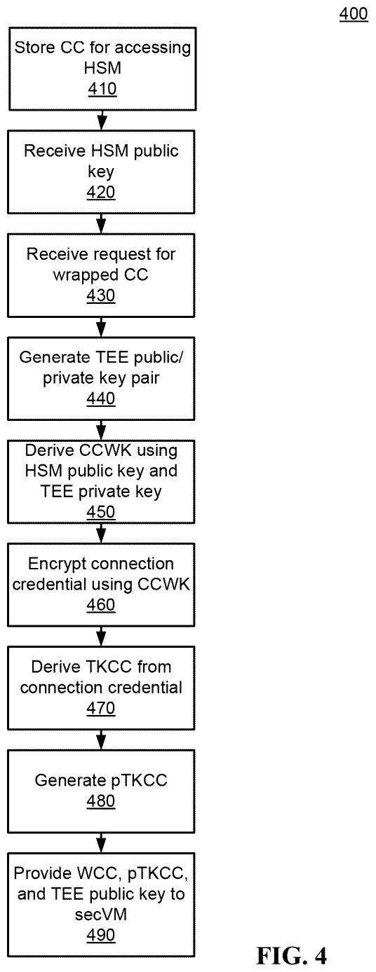

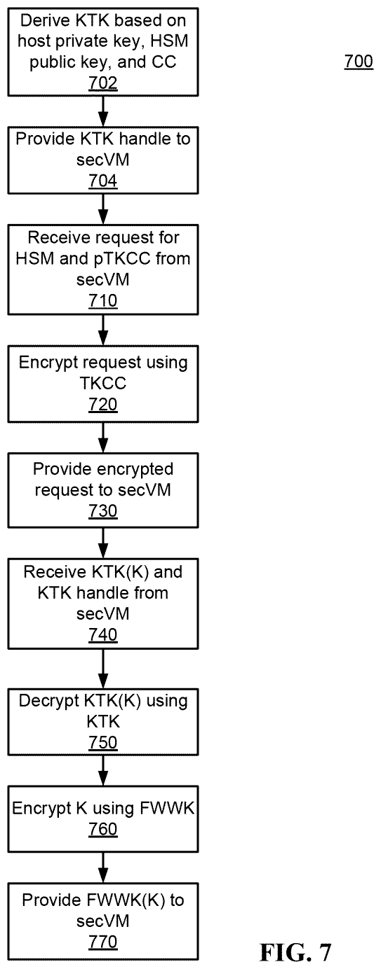

TEE 220 contains secure connection module 222 configured to perform operations in establishing a secure connection between secVM 210 and remote HSM 230. Secure connection module 222 may be configured to perform some or all of the operations of method 400 described herein and depicted in FIG. 4. TEE 220 further contains transform module 226 configured to perform operations to transform an HSM protected key into a host firmware protected key. Transform module 226 may be configured to perform some or all of the operations of method 700 described herein and depicted in FIG. 7.

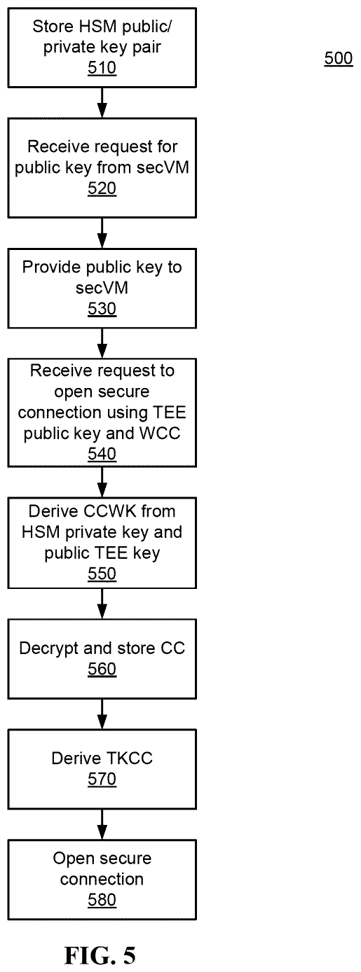

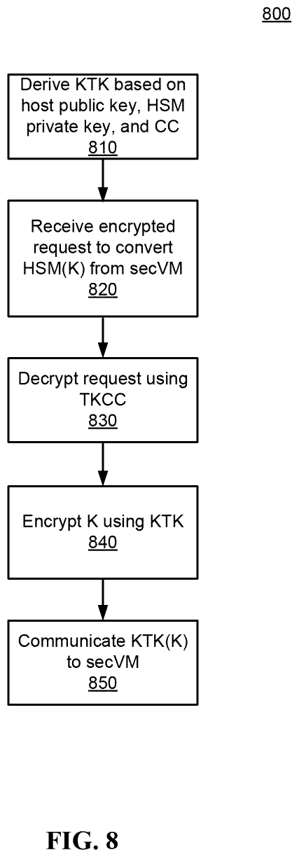

Remote HSM 230 contains secure connection module 232 configured to establish a secure connection with secVM 210. Secure connection module 232 may be configured to perform some or all of the operations of method 500 described herein and depicted in FIG. 5. Remote HSM 230 may further contain transform module 236 configured to perform operations to transform an HSM protected key into a host firmware protected key. Request module 236 may be configured to perform some or all of the operations of method 800 described herein and depicted in FIG. 8.

Referring now to FIG. 3, a flowchart of an example method 300 for a secVM to establish a secure connection to a remote HSM is depicted, according to embodiments. At operation 310, the secVM requests an HSM public key from a remote HSM. At operation 320, the secVM receives the HSM public key from the remote HSM. At operation 325, the secVM provides the HSM public key to the TEE. At operation 330, the secVM requests a wrapped connection credential (CC) from a TEE. At operation 340, the secVM receives a wrapped CC, protected transport key (pTKCC), and the TEE public key from the TEE. The wrapped CC is a CC that has been encrypted by the TEE using a connection credential wrapping key (CCWK). The protected transport key is a protected version of the transport key (TKCC) for the connection opened with the connection credential CC that will be used to encrypt communication between the secVM and remote HSM. The protected transport key may be the TKCC encrypted by a host firmware wrapping key (FWWK) to produce FWWK(TKCC). At operation 350, the secVM requests a secure connection with the HSM using the TEE public key and the wrapped CC. As described herein, the remote HSM may use the TEE public key to derive the CCWK, decrypt the wrapped CC to obtain and store the CC, and open the secure connection with the secVM.

Referring now to FIG. 4, a flowchart of an example method 400 for a TEE establishing a secure connection between a secVM and remote HSM is depicted, according to embodiments. At operation 410, the TEE stores a connection credential (CC) for accessing the remote HSM. At operation 420, the TEE receives the HSM public key from the secVM. At operation 430, the TEE receives a request for a wrapped CC (WCC) from the secVM. At operation 440, the TEE generates a public/private key pair.

At operation 450, the TEE derives a connection credential wrapping key (CCWK) using the HSM public key and the TEE private key, for example, using a NIST approved key derivation algorithm to derive a key from a common secret computed using an Elliptic Curve Diffie-Hellman scheme. At operation 460, the TEE encrypts the CC using the CCWK. At operation 470, the TEE derives the TKCC from the CC. Any suitable derivation algorithm may be used as long as the remote HSM uses the same derivation algorithm. In some embodiments, the TEE and remote HSM may be preconfigured to use a particular derivation algorithm. In some embodiments, the TEE and remote HSM may negotiate a derivation algorithm to use. At operation 480, the TEE generates a protected TKCC (pTKCC). The pTKCC is a key representation that does not disclose the TKCC value, but may be used as input to cryptographic operations performed by the TEE (or other trusted hardware/firmware). In some embodiments, the pTKCC may be the TKCC encrypted by the host firmware wrapping key (FWWK(TKCC)). At operation 490, the TEE provides the WCC, the pTKCC, and the TEE public key to the secVM. The secVM, as described herein, may use the WCC and TEE public key to open a secure connection with the remote HSM. The pTKCC, as described herein, allows for communication between the secVM and the HSM to be encrypted using the TKCC.

Referring now to FIG. 5, a flowchart of an example method 500 for an HSM to establish a secure connection to a remote secVM, according to embodiments. At operation 510, the HSM stores a public/private key pair. At operation 520, the HSM receives a request for an HSM public key from the secVM. At operation 530, the HSM provides the HSM public key to the secVM. At operation 540, the HSM receives a request from the secVM to open a secure connection using a TEE public key and a wrapped connection credential (WCC). At operation 550, the HSM derives a connection credential wrapping key (CCWK) from the HSM private key and the TEE public key, for example, using a NIST approved key derivation algorithm to derive a key from a common secret computed using an Elliptic Curve Diffie-Hellman scheme. At operation 560, the HSM decrypts the WCC using the CCWK and stores the connection credential (CC). At operation 570, the HSM derives the transport key (TKCC) using the CC. At operation 580, the HSM opens the secure connection with the secVM.

Referring now to FIG. 6, a flowchart of an example method 600 for a secVM transforming an HSM protected key into a host FW protected key is depicted, according to embodiments. At operation 605, the secVM receives a key transport key (KTK) handle from the TEE. At operation 610, the secVM provides a request (R) for the HSM to transform an HSM protected key into a host FW protected key and the pTKCC to the TEE to encrypt the request. At operation 620, the secVM receives an encrypted request (TKCC(R)) from the TEE that has been encrypted using the TKCC. At operation 630, the secVM communicates the encrypted request to the remote HSM. At operation 640, the secVM receives an encrypted plaintext key (KTK(K)) which is the plaintext key corresponding to the HSM protected key that has been encrypted using a key transport key (KEK). In some embodiments, the KTK(K) received from the HSM has been encrypted using the TKCC. At operation 650, the secVM provides the KTK(K) and the KTK handle to the TEE. In some embodiments, the secVM provides the encrypted KTK(K) (encrypted using the TKCC) and the pTKCC to the TEE for decryption to obtain the KTK(K). At operation 660, the secVM receives a wrapped K (FWWK(K)) from the TEE that has been wrapped by the host firmware wrapping key (FWWK) specific to the secVM.

Referring now to FIG. 7, a flowchart of an example method 700 for a trusted TEE transforming an HSM protected key into a host FW protected key is depicted, according to embodiments. At operation 702, the TEE derives KTK based a on connection credential, a host private key, and an HSM public key. At operation 704, the TEE provides a KTK handle to the secVM. The KTK handle is a reference to the KTK. For example, the KTK handle may be a name that identifies the KTK or a location where the KTK is stored. The TEE is configured to reject all operations using the KTK handle except an operation to unwrap a key using the KTK and return the resulting unwrapped key wrapped by the FWWK. At operation 710, the TEE receives a request for the HSM to transform an HSM protected key into a host FW protected key and the pTKCC from the TEE. At operation 720, the TEE encrypts the request using the TKCC. In some embodiments, the pTKCC is input into cryptographic operations to derive the TKCC. At operation 730, the encrypted request is provided to the secVM for communication to the remote HSM. At operation 740, the TEE receives the KTK(K) (plaintext key K encrypted by the KTK) and the KTK handle. In some embodiments the KTK(K) is encrypted using the TKCC and the TEE receives the encrypted KTK(K) from the secVM with the pTKCC. At operation 750, the TEE decrypts the KTK(K) using the KTK referenced by the KTK handle. At operation 760, the plaintext key (K) is wrapped using the host FW wrapping key (FWWK(K)) specific to the secVM to create FWWK(K). At operation 770, the FWWK(K) is returned to the secVM.

Referring now to FIG. 8, a flowchart of an example method 800 for an HSM transforming an HSM protected key into a host FW protected key, according to embodiments. At operation 810, the HSM derives the KTK based on a host public key, HSM private key, and the CC. The HSM may be preloaded with the host public key, for example, in a host certificate.

At operation 820, the HSM receives an encrypted request to transform an HSM protected key (HSM(K)) into a host FW protected key via secure connection CCID, where CCID is the name of the connection that was opened with the CC. At operation 830, the request is decrypted using the TKCC. At operation 840, the plaintext key (K) corresponding to HSM(K) is encrypted by the HSM using the KTK to produce KTK(K). At operation 850, the HSM communicates KTK(K) to the secVM.

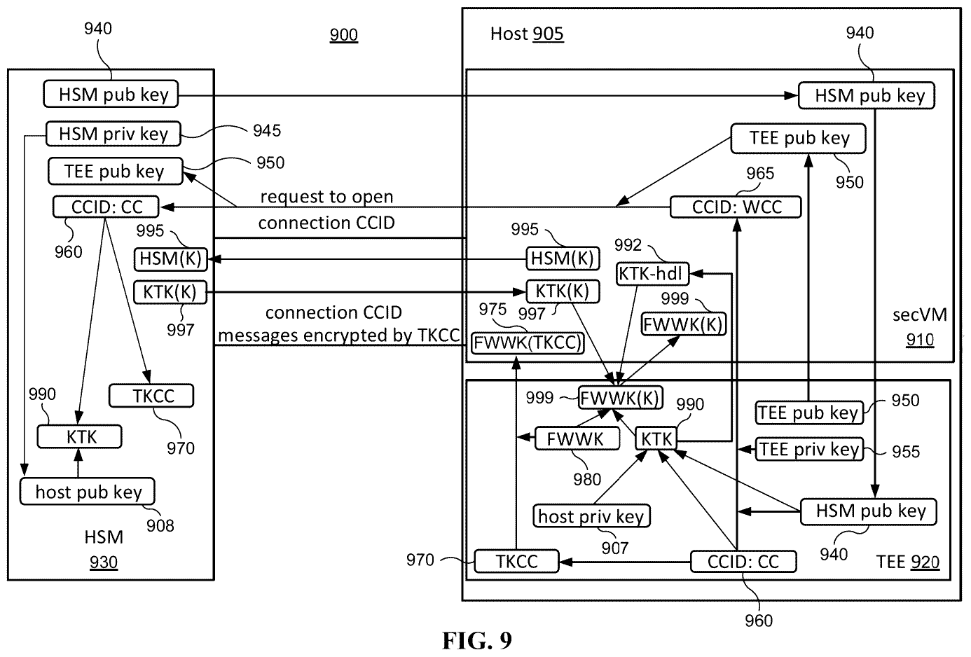

Referring now to FIG. 9, a block diagram of an example computing environment 900 showing an example flow of keys and credentials used in establishing a secure connection between secVM 910 and HSM 930 and transforming an HSM protected key into a host FW protected key is depicted, according to embodiments.

Host 905 contains secVM 910 and TEE 920. Host 905 may be, for example, a server. HSM 930 has a public key 940 and a corresponding private key 945. HSM 930 shares its public key 940 with secVM 910 (e.g., in response to a request from secVM 910). SecVM 910 shares the public key with TEE 920 (e.g., with a request for a wrapped connection credential (WCC)). TEE 920 generates a Diffie-Hellman key pair including public key 950 and private key 955. As part of the Diffie-Hellman CCWK negotiation process, the TEE 920 shares its public key 950 with HSM 930 via secVM 910, and uses its private key 955 and the HSM public key 940. TEE 920 generates a connection credential for the secure connection (CCID: CC 960). TEE 920 derives the transport key (TKCC 970) for the secure connection from the CCID: CC 960. TEE 920 provides a wrapped CC for the secure connection (CCID: WCC 965) that has been wrapped with the negotiated CCWK. TEE 920 also provides a protected version of the TKCC 975 (FWWK(TKCC) that has been wrapped using host firmware wrapping key (FWWK) 980 to secVM 910. SecVM 910 provides the CCID: WCC 965 to HSM 930 (e.g., with a request to open secure connection CCID). HSM 930 unwraps the CCID: WCC 965 with the CCWK to obtain CCID: CC 960. HSM 930 derives TKCC 970 from CCID: CC 960. HSM 930 then opens the secure connection CCID with secVM 910, where communication over CCID is encrypted using TKCC 970. As depicted, the plaintext values of CCID: CC 960 and TKCC 970 are not stored in secVM 910 where they may be vulnerable.

TEE has the privileges to access to the host private key 907. The host private key 907 may be securely stored inside the host 905 and outside of the TEE. TEE 920 derives a key transport key (KTK) 990 from a host private key 907, the CCID: CC 960, and the HSM public key 940. TEE 920 provides a KTK handle 992 to the secVM 910. SecVM 910 communicates an HSM protected key (HSM(K)) 995 with a request to transform it into a host firmware protected key. HSM 930 derives the KTK 990 from HSM private key 945, host public key 908, and CCID: CC 960. HSM 995 encrypts plaintext key (K) corresponding to HSM(K) with KTK 990 to generate KTK(K) 997. HSM 995 communicates KTK(K) 997 to secVM 910. SecVM 910 provides KTK(K) 997 and KTK handle 992 to TEE 920. TEE 920 decrypts KTK(K) 997 and encrypts the resulting plaintext key (K) with FWWK (980) to generate the host firmware protected key (FWWK(K)) 999. TEE 920 returns FWWK(K) 999 to secVM 910. Notably, KTK 990 and FWWK 980 are not stored in plaintext in secVM 910 where they may be vulnerable.

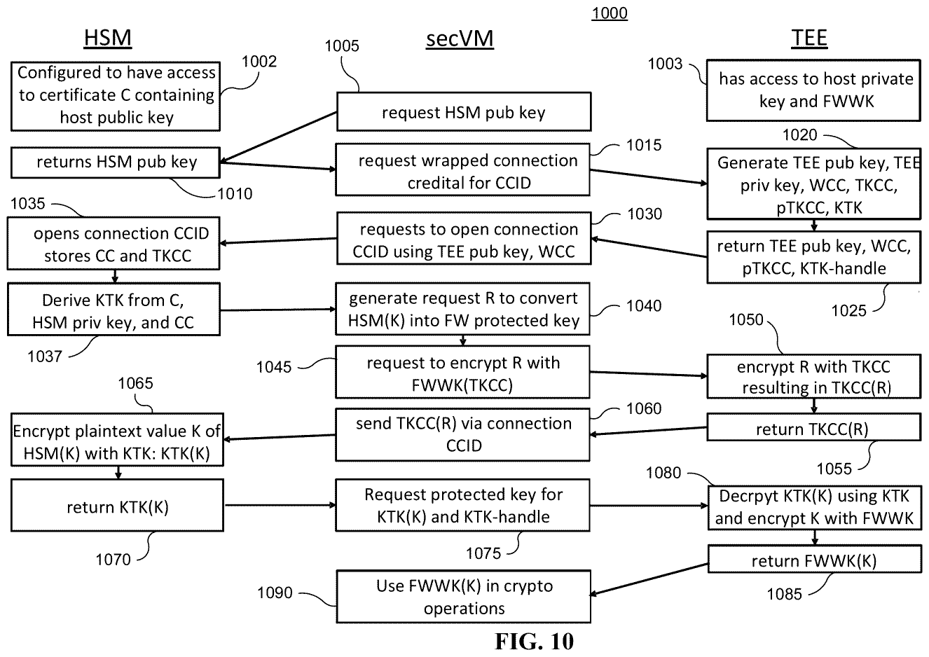

Referring now to FIG. 10, a sequence diagram 1000 of example operations between a secVM, HSM, and TEE are depicted according to embodiments. At operation 1002, the HSM is configured to have access to certificate C containing a host public key which corresponds to a host private key. At operation 1003, the TEE is configured to have access to the host private key and a host firmware wrapping key (FWWK).

At operation 1005, the secVM requests an HSM public key from the HSM. At operation 1010, the HSM returns the HSM public key to the secVM. At operation 1015, the secVM requests a wrapped connection credential for a secure connection with the HSM (CCID) from the TEE. The request includes the HSM public key. At operation 1020 the TEE generates a public/private key pair, generates a wrapped connection credential (WCC), derives a transport key (TKCC), generates a protected transport key (pTKCC), and derives a key transport key (KTK). At operation 1025, the TEE returns the TEE public key, WCC, the pTKCC, and a KTK handle to the secVM. At operation 1030, the secVM requests to open secure connection CCID using the TEE public key and the WCC. At operation 1035, the HSM opens secure connection CCID, unwraps and stores the CC, and derives and stores the TKCC. At operation 1037, the HSM derives KTK from a host public key within certificate C, an HSM private key, and the CC. At operation 1040, the secVM generates a request (R) to convert an HSM protected key (HSM(K)) into a host FW protected key for the HSM. At operation 1045, the secVM provides a request to encrypt R with the pTKCC to the TEE. At operation 1050, the TEE encrypts R with the TKCC, resulting in TKCC(R). At operation 1055, the TEE returns the TKCC(R) to the secVM. At operation 1060, the secVM sends the TKCC(R) to the HSM via the secure connection CCID. At operation 1065, the HSM encrypts a plaintext value K corresponding to the HSM(K) with the KTK to generate KTK(K). At operation 1070, the HSM returns the KTK(K) to the secVM. At operation 1075, the secVM requests a host FW protected key from the TEE with the KTK(K) and the KTK handle. At operation 1080, the TEE decrypts KTK(K) using the KTK and encrypts K with the FWWK to generate FWWK(K). At operation 1085, the TEE returns the FWWK(K) to the secVM. At operation 1090, the secVM uses the FWWK(K) in cryptographic operations.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for transforming a hardware security module (HSM) protected key (HSM(K)) into host firmware (FW) protected key (FWWK(K)) that is specific to a secure virtual machine (secVM), the method comprising:
storing, by a trusted execution module (TEE), a connection credential (CC);
receiving a request from the secVM for data to open a connection based on the CC with an HSM;
providing, by the TEE, the data to open the connection based on the CC to the secVM;
deriving, by the TEE, a key transport key (KTK) using the CC, a host private key, and an HSM public key;
providing, by the TEE, a KTK handle to the secVM;
receiving, by the TEE and from the secVM, the KTK handle and a wrapped plaintext key (KTK(K)) wrapped using the KTK, wherein the plaintext key (K) corresponds to the HSM protected key;
unwrapping, by the TEE, the KTK(K) using the KTK referenced by the KTK handle to produce the K;
wrapping, by the TEE, the K with a secVM specific host FW wrapping key (FWWK) to create the FWWK(K); and
providing, by the TEE, the FWWK(K) to the secVM.

2. The method of claim 1, wherein:
the HSM is configured with a host public key corresponding to the host private key;
the HSM derives the KTK using the CC of the open connection, the host public key and an HSM private key stored on the HSM; and
the KTK(K) is generated by the HSM upon request from the secVM via the connection opened with the CC, the HSM wrapping the plaintext key (K) using the KTK to generate KTK(K) and the HSM returns the KTK(K) to the secVM.

3. The method of claim 1, further comprising:
deriving, by the TEE, a connection credential wrapping key (CCWK), wherein the CCWK is derived using the TEE private key and the HSM public key; and
wrapping, by the TEE, the CC to produce a wrapped connection credential (WCC), wherein the data to open the connection based on the CC comprises the WCC and the TEE public key.

4. The method of claim 1, further comprising:
deriving, by the TEE, a transport key (TKCC) from the CC;
wrapping, by the TEE, the TKCC with the FWWK, to produce a wrapped TKCC (FWWK(TKCC)); and
providing, by the TEE, the FWWK(TKCC) to the secVM, wherein communication over the connection is encrypted using the TKCC.

5. The method of claim 4, further comprising:
receiving, by the TEE, the FWWK(TKCC) and a request (R) for the HSM to transform the HSM(K) into a host FW protected key;
encrypting the R using the TKCC to produce TKCC(R); and
providing, by the TEE, TKCC(R) to the secVM.

6. The method of claim 4, further comprising:
receiving the FWWK(TKCC) and the KTK(K) wrapped by the TKCC from the secVM.

7. The method of claim 1, wherein the host private key is only accessible by the TEE.

8. The method of claim 1, wherein the HSM(K) is bound to the CC associated with the connection used to transport the HSM(K) to the secVM.

9. The method of claim 1, wherein TEE rejects all operations using the KTK handle except an operation to unwrap a key using the KTK and return the resulting unwrapped key wrapped by the FWWK.

10. A system for transforming a hardware security module (HSM) protected key (HSM(K)) into a host firmware (FW) protected key (FWWK(K)) that is specific to a secure virtual machine (secVM), the system comprising:
a trusted execution environment (TEE) comprising hardware and firmware configured to:
store a connection credential (CC),
provide data to open a connection based on the CC to the secVM,
derive a key transport key (KTK) using the CC, a host private key, and an HSM public key,
provide a KTK handle to the secVM,
receive, from the secVM, the KTK handle and a wrapped plaintext key (KTK(K)) wrapped using the KTK, wherein the plaintext key (K) corresponds to the HSM protected key,
KTK(K) using the KTK referenced by the KTK handle to produce the K,
wrap the K with a secVM specific host FW wrapping key (FWWK) to create the FWWK(K), and
provide the FWWK(K) to the secVM; and
the secVM configured to:
establish a connection with the HSM using the data to open the connection based on the CC from the TEE;
communicate a request (R) to convert the HSM (K) into a host FW protected key to the HSM via the connection;
in response to the R, receive the KTK(K) from the HSM;
provide the KTK(K) and the KTK handle to the TEE; and
receive the FWWK(K) from the TEE.

11. The system of claim 10, wherein the TEE is further configured to:
derive a connection credential wrapping key (CCWK), wherein the CCWK is derived using the TEE private key and the HSM public key; and
wrap the CC to produce a wrapped connection credential (WCC), wherein the data to open the connection based on the CC comprises the WCC and the TEE public key.

12. The system of claim 10, wherein the TEE is further configured to:
derive a transport key (TKCC) from the CC;
wrap the TKCC with the FWWK, to produce a wrapped TKCC (FWWK(TKCC)); and
provide the FWWK(TKCC) to the secVM, wherein communication over the connection is encrypted using the TKCC.

13. The system of claim 12, wherein the communicating the R to the HSM via the connection comprises:
communicating, by the secVM, the R and the FWWK(TKCC) to the TEE;
receiving, by the secVM, the R encrypted by the TKCC (TKCC(R)); and
communicating the TKCC(R) to the HSM.

14. The system of claim 12, wherein the TEE is further configured to receive the FWWK(TKCC) and the KTK(K) wrapped by the TKCC from the secVM.

15. The system of claim 10, wherein the host private key is only accessible by the TEE.

16. The system of claim 10, wherein the HSM(K) is bound to the CC associated with the connection used to transport the HSM(K) to the secVM.

17. The system of claim 10, further comprising:
the HSM configured to:
store a host public key; and
derive the KTK using the host public key and CC.

18. A computer program product comprising a computer-readable storage medium storing instructions that, when executed by a processor, cause the processor to perform a method for transforming a hardware security module (HSM) protected key (HSM(K)) into host firmware (FW) protected key (FWWK(K)) that is specific to a secure virtual machine (secVM), the method comprising:
requesting data to open a connection based on connection credentials (CC) with the HSM from a trusted execution environment (TEE);
receiving the data to open the connection based on the CC;
receiving a key transport key (KTK) handle from the TEE;
establishing the connection with the HSM using the data;
requesting to transform the HSM(K) to a host protected key via the connection;
receiving a wrapped plaintext key (KTK(K)) wrapped using the KTK from the HSM;
providing the KTK(K) and the KTK handle to the TEE; and
receiving the FWWK(K) from the TEE.

19. The computer program product of claim 18, wherein the data to open the connection comprises a wrapped connection credential and an encrypted transport key associated with the connection credential.

20. The computer program product of claim 19, wherein the requesting to transform the HSM(K) to a host protected key via the connection comprises:
generating a request (R) to transform the HSM(K) to a host protected key;
providing R to the TEE with the encrypted transport key;
receiving an encrypted R; and
communicating the encrypted R to the HSM.
